(19) United States
(12) Patent Application Publication
(10) Pub. No.: US 2012/0145638 A1
(43) Pub. Date: Jun. 14, 2012

(54) METHOD AND COMPOSITION OF A SUPERTETRAHEDRAL CATIONIC FRAMEWORK FOR ION EXCHANGE

(76) Inventors: Thomas E. Albrecht-Schmitt, Mishawaka, IN (US); Evgeny V. Alekseev, Kiel (DE); Shuao Wang, South Bend, IN (US); Wulf Depmeier, Kiel (DE)

(21) Appl. No.: 13/113,904

(22) Filed: May 23, 2011

Related U.S. Application Data
(60) Provisional application No. 61/459,535, filed on Dec. 14, 2010.

(51) Int. Cl. B01D 35/00; B01J 39/10; C01B 35/18

(52) U.S. Cl. 210/681; 423/263; 423/252; 252/184

(57) ABSTRACT

A cubic compound may comprise thorium borate or, in the alternative cerium borate, and may possess a porous supertetrahedral cationic framework with extraframework borate anions. These anions are readily exchanged with a variety of environmental contaminants, especially those from the nuclear industry, including chromate and pertechnetate.

### CROSS REFERENCE TO RELATED APPLICATIONS

This application claims priority to U.S. Provisional Application No. 61/459,535, filed Dec. 14, 2010, entitled, “METHOD AND COMPOSITION OF A SUPERTETRAHEDRAL CATIONIC FRAMEWORK FOR ION EXCHANGE.” The entire content of the above-identified application is hereby expressly incorporated by reference.

### STATEMENT REGARDING FEDERALLY SPONSORED R&D

This invention was made with government support under the United States Department of Energy and under Contract Nos. DE-FG02-01ER15187, DE-FG02-01ER16026, and DE-SC0001089. The government has certain rights in the invention.

### BACKGROUND

1. Field of the Invention

The present disclosure relates to supertetrahedral cationic frameworks configured for ion exchange.

2. Description of the Related Art

Materials with extended structures are typically based on an anionic network where the charge is balanced by cations that fill the space between the anionic portions of the structure. This general description applies to a vast array of functional materials. However, a rare alternative to this concept, is a solid with a cationic extended structure, whose charge is balanced by unbound anions. Until recently, materials of this kind were largely represented by the hydrotalcite clays. These layered double hydroxides, which occur with many different metal ions, possess metal hydroxide slabs with interlayer anions that can be easily exchanged, making them extremely important for a variety of environmental applications. Other examples of cationic solids include the mineral francisite and its derivatives, Cu₃BiSe₂O₈X (X=P, CI, Br, I). However, the anions in these compounds cannot be exchanged for larger ones without collapse of the framework. A series of heavy main group hydroxides and fluorides have recently been reported that possess cationic layers. The anions between these layers can be exchanged, allowing for the removal of key environmental contaminants from solution.

There are two key anions that are inherent to the nuclear weapons complex legacy of the Cold War as well as advanced nuclear fuel cycles; these are chromate ion (CrO₄²⁻) and pertechnetate ion (TcO₄⁻). The former is toxic from a chemical standpoint, and the latter is radioactive. Both are transported in the environment, and both are problematic during the vitrification of nuclear waste. Chromate forms spinels within the glass, weakening the integrity of the waste form, and pertechnetate easily leaches from the glass. There is a need for technology to easily sequester these species from solution.

### SUMMARY

In accordance with one embodiment, a composition comprising a compound is provided. The compound has the formula: [XB₅O₆(OH)₆][BO(OH)₂] (Formula 1) or hydrates thereof, wherein X is selected from the group consisting of Th or Ce. The compound comprises a porous supertetrahedral cationic framework.

In accordance with another embodiment, method of sequestering environmental contaminants is provided. The method comprises: treating a liquid with a compound represented by the formula, [XB₅O₆(OH)₆][BO(OH)₂] or hydrates thereof, wherein X is selected from the group consisting of Th or Ce. The environmental contaminant may comprise chromate anions (CrO₄²⁻) or pertechnetate ions (TeO₄⁻). In one embodiment, the compound has the formula [ThB₅O₆(OH)₆][BO(OH)₂].nH₂O, where the level of hydration can be 0≦n≦4, including for example n=2.5.

For purposes of summarizing the invention, certain aspects, advantages and novel features of the invention have been described herein above. Of course, it is to be understood that not necessarily all such advantages may be achieved in accordance with any particular embodiment of the invention. Thus, the invention may be embodied or carried out in a manner that achieves or optimizes one advantage or group of advantages as taught or suggested herein without necessarily achieving other advantages as may be taught or suggested herein.

All of these embodiments are intended to be within the scope of the invention herein disclosed. These and other embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1A illustrates an example of a view of a twelve-coordinate icosahedral geometry around Th⁴⁺ centers in NDTB-1.

FIG. 1B illustrates an example of B₁₀O₂₄ (4 trigonal planar structures of BO₃, 6 tetrahedral structures of BO₄) clusters with threefold symmetry that bridge between the Th⁴⁺ centers in NDTB-1.

FIG. 2A illustrates an example of a supertetrahedral fragment in NDTB-1, with icosahedral geometry surrounding thorium centers, and trigonal or tetrahedral geometries surrounding borate ions.

FIG. 2B illustrates a topology of an example of a supertetrahedral 3-D framework based on Th-atoms.

FIG. 3A illustrates a view along [110] direction of an example of a 3D structure of NDTB-1, with the disordered BO₃ anions and water that reside in the channels omitted.

FIG. 3B illustrates a cage topology in the structure of an example of NDTB-1.

FIG. 4A illustrates an example of a solid-state ¹¹B MAS NMR spectrum of NDTB-1 at 160.45 MHz and 15 kHz spinning rate

FIG. 4B illustrates an example of a least-squares fit comprising a sum of three components corresponding to ordered BO₃ and BO₄ groups and disordered BO₃⁻ anions within the channels.

FIG. 5 illustrates an example of an UV-vis spectra of TcO⁴⁻ showing its removal from solution by crystals of NDTB-1 at 0, 1, 8, and 36 hours.

FIGS. 6A-6D illustrate exemplary photographs of NDTB-1 with various anions captured within the its structure.

FIG. 7A illustrates an example of a ⁹⁹Tc MAS-NMR spectrum of NDTB-1.

FIG. 7B illustrates an example of a ⁷⁷Se MAS-NMR spectrum of NDTB-1.

### DETAILED DESCRIPTION

Thorium borates are poorly described in the literature, with only a single crystallographically characterized example known, ThB₂O₅. This paucity is surprising in light of the fact that a thorium borate was reported by J. J. Berzelius in 1826. In the course of attempting to understand crystallized portions of vitrified nuclear waste, a highly unusual thorium borate was discovered, [ThB₅O₆(OH)₆][BO(OH)₂].2.5H₂O (hereinafter “NDTB-1”). The preparation of NDTB-1 and related compounds according to Formula 1 can be accomplished through the use of a boric acid reactive-flux, whereas previous investigations utilized either aqueous precipitation at room temperature or high temperature B₂O₃ melts to prepare other thorium borate compounds.

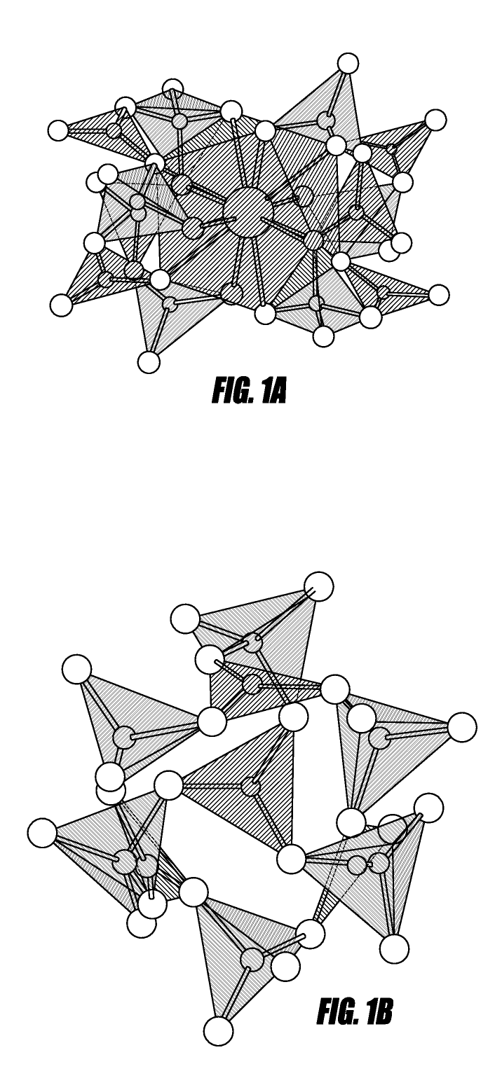

FIG. 1A illustrates an example of a view of a twelve-coordinate icosahedral geometry around Th⁴⁺ centers in NDTB-1. The structure of NDTB-1 is a porous supertetrahedral 3D framework. The micro building blocks of this framework can be twelve-coordinate Th⁴⁺ surrounded by BO₃ and BO₄ anions. The BO₄ anions can chelate the thorium centers, and the BO₃ groups can occupy single vertices as shown in FIG. 1A. The structure of the BO₃ anions can be trigonal planar and the structure of the BO₄ anions can be tetrahedral. The ratio of the number of BO₃/BO₄ anions can be 2:3. The thorium atoms can reside on a site yielding an almost regular icosahedron with Th—O bond distances of 2.566(3) (×6) and 2.575(2) (×6) Å. This coordination number is known from classical anions such as [Th(NO₃)₆]²⁻, and is accomplished by combining the large size of the Th⁴⁺ cation (1.21 Å) with the small size and chelating nature of the borate anions.

In another embodiment, the compound NDTB-1 and other compounds according to Formula 1 (which includes other hydrates and non-hydrated compounds according to the formula) may replace the thorium with cerium. As such, this disclosure is not meant to limit that which is disclosed herein to the particular thorium borate compound described above (i.e. NDTB-1), but can also be taken to include a cerium borate compound, where cerium replaces the presence of some or all of the thorium as well as other compounds according to Formula 1. Accordingly, although much of the description herein refers specifically to NDTB-1, one skilled in the art will understand that the description is applicable to other compounds according to Formula 1. In some embodiments, the composition can comprise all thorium borate, all cerium borate, or a mixture of thorium and cerium borate compounds.

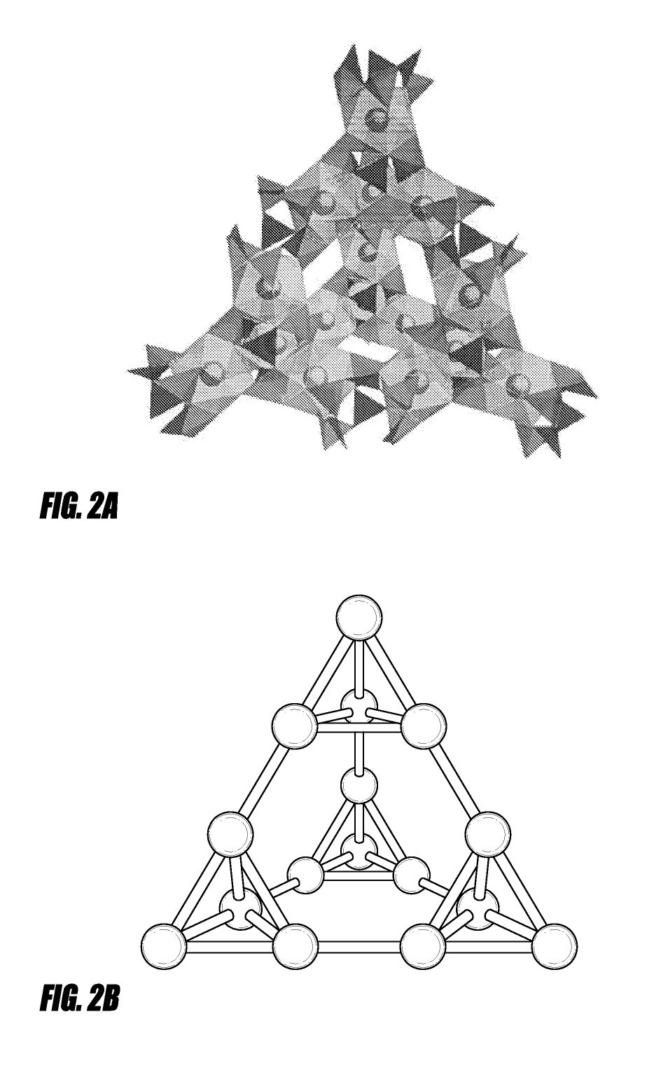

FIG. 1B illustrates an example of B₁₀O₂₄ (4 trigonal planar structures, 6 tetrahedral structures) clusters with threefold symmetry that bridge between the Th⁴⁺ centers in NDTB-1. Borate anions may be polymerized and can form the B₁₀O₂₄ clusters with threefold symmetry that bridge between the thorium centers, and the hydroxide bridge between borate groups can be inferred from bond distances and bond-valence considerations. The bridging of the thorium centers by the borate clusters creates a supertetrahedral framework depicted in two formats in FIG. 2.

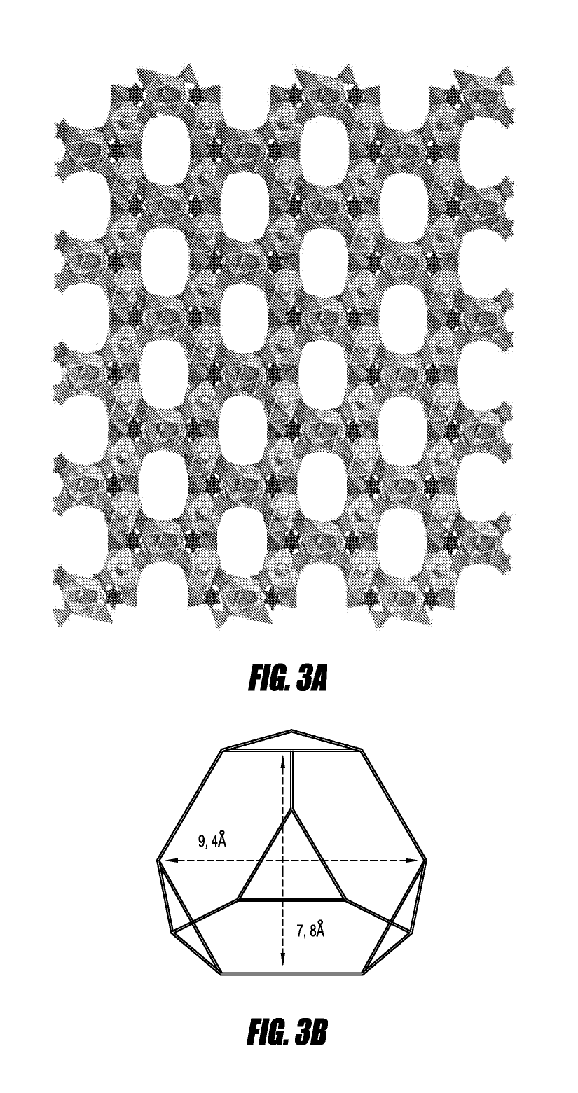

One of the key features of NDTB-1 and related compounds are the channels that extend along direction [110]. A view of the structure of this material is shown in FIG. 3A. X-ray diffraction studies reveal the presence of a highly disordered entity within the channels.

Thorium, or alternatively cerium atoms, and B₁₀O₂₄ crown-like groups may not fill all of the space in the supertetrahedra, and as a result of this architecture, large free voids in the structure of NDTB-1 are observed. The result of such combination is a regular 3D framework with a system of channels and cages. A general view of an example of an NDTB-1 structure along the [110] direction is shown in FIG. 3A. The six channels can form a network that pierces the whole structure, and allows facile anionic and molecular transport for the exchange processes (vide infra). These channels intersect in the center of the supertetrahedra. The gates into the intersecting chamber have a hexagonal form and can be 9.4×7.4 Å in size, as illustrated in FIG. 3B. In this embodiment, each cage can have four identical gates, and forms truncated tetrahedra. Free void volume in NDTB-1 is 43%, which makes it the second most porous actinide compound currently known. The channel directions are at an angle of 30° to the gates, and in FIG. 3A an ellipse-like channel profile is observed. The preparation of this material from multiple sources as well as charge balance considerations can lead a person of skill in the art to suspect that disordered borate reside in the channels of NDTB-1.

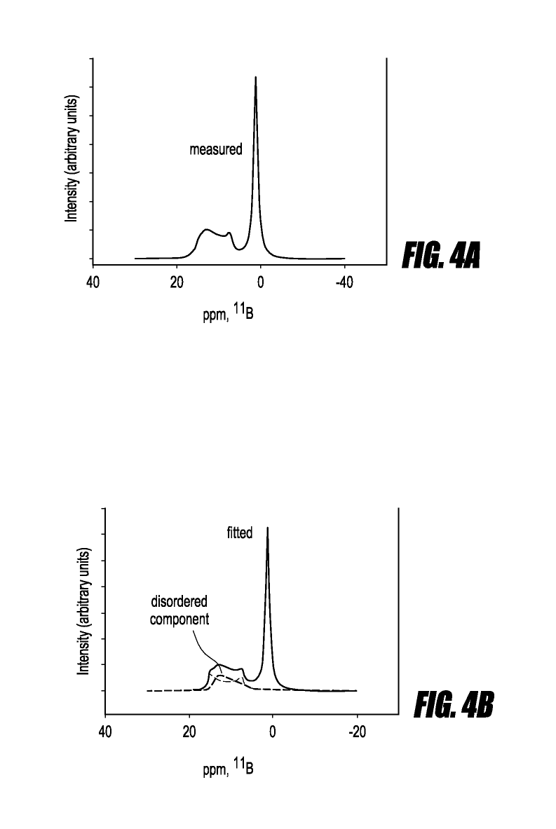

In FIG. 4A, solid-state ¹¹B MAS NMR spectra show distinct signals from well-ordered BO₃ and BO₄ groups, as found from the single-crystal X-ray diffraction (XRD) data. As shown in FIG. 4B, the ordered BO₃ groups yield a characteristic MAS powder pattern (dashed) with horns that correspond to the steep edge near +15 ppm and the peak at +7.5 ppm, best fit with an isotropic chemical shift δ=17.5 ppm and quadrupolar coupling parameters Cq=2.65 MHz, η=0. However, a powder pattern for a well-ordered site cannot account for the broad area of intensity from 14 to 10 ppm, between the sharper BO₃ features. This intensity can be explained by the presence of a second BO₃ environment that experiences a distribution of electric field gradients, as shown in FIG. 4B, which can be calculated using a method described by D. Coster, A. L. Blumenfeld, J. J. Fripiat, J. Phys. Chem. 1994, 98, 6201-6211, the entirety of which is hereby incorporated by reference.

A least-squares fit of the spectrum yielded for this disordered BO₃ an approximately Gaussian distribution of Cq values with a full-width of 0.9 MHz centered at an average of 2.0 MHz. Although these values are not well-constrained in detail, a component profile of this general shape accounts for the difference between the observed spectrum and the lineshape expected for well-ordered BO₃. This feature is in accord with the presence of a disordered BO₃ group as suspected from the crystal structure. In addition, the ratio of BO₃ to BO₄ integrated intensity, 0.82(5), exceeds that expected from the 2:3 crystallographic ratio of the framework and provides further support for the existence of additional BO₃ groups in the channels. When the single crystal X-ray data and solid-state NMR spectroscopy are taken together, it can be concluded that NDTB-1 is an exceedingly rare example of a cationic framework with extraframework borate anions residing in the symmetrical centers of the gates being used to maintain charge neutrality.

Anion exchange experiments can be conducted with a variety of common anions, beginning with halides. These studies, which combine inductively coupled plasma mass spectroscopy (ICP-MS), energy dispersive spectroscopy (EDS), and single crystal and powder X-ray diffraction, reveal that not only can anion exchange take place, but that the structure can remain intact throughout the exchange. More impressive is that fact that single crystals can retain their integrity throughout the exchange, although with these small anions, disorder in the channels remains a crystallographic problem.

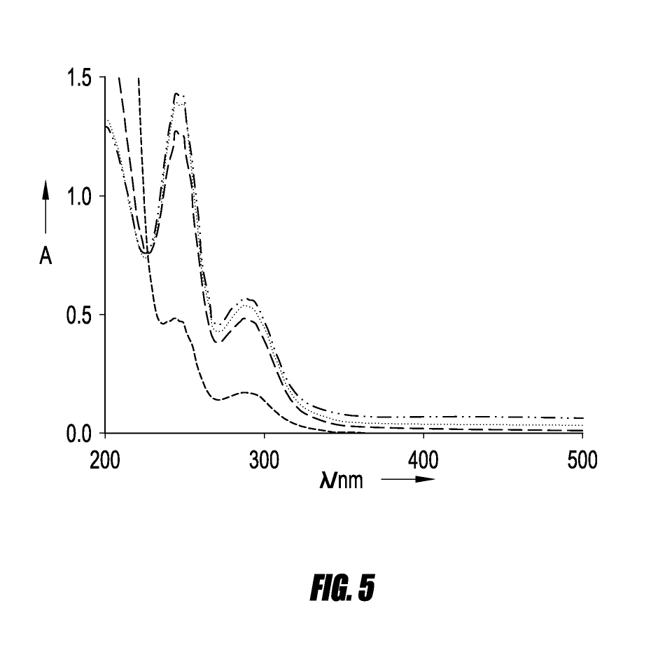

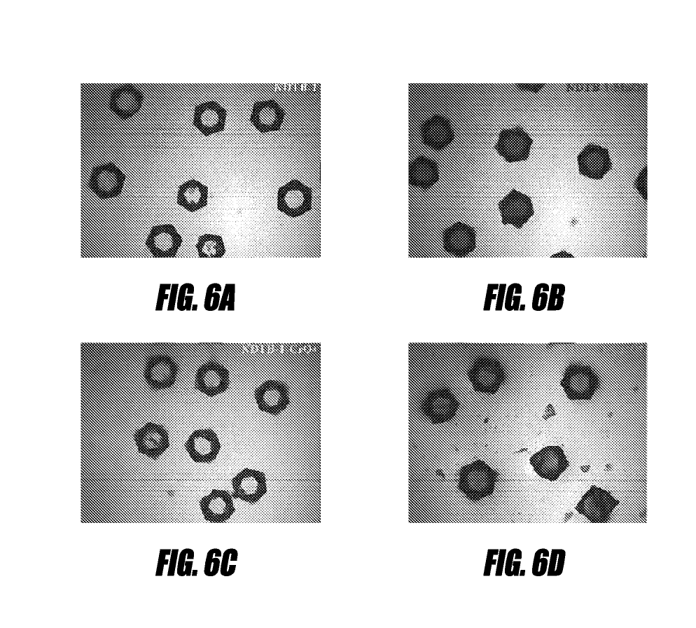

Exchange experiments can be conducted with a variety of highly colored anions, such as but not limited to MnO₄⁻, CrO₄²⁻, Cr₂O₇²⁻, ReO₄⁻, and AuCl₄⁻ (IO₃⁻ and SeO₃²⁻ can also be studied). The single crystals show the color of the transition metal anions within a few minutes. FIG. 5 illustrates a UV-vis-NIR spectrum absorption data using a micro-spectrophotometer that were collected from single crystals after exchange, and these clearly demonstrate the presence of the anions within the crystals. As illustrated in FIG. 6, the crystals can be cut, and the interior fluoresces a specific color according to the presence of the anions. The critical anion exchange experiments reveal the replacement of the extra framework borate anions with TcO₄⁻. Owing to the intense nature of the charge transfer bands of TcO₄⁻ (pertechnetate), relatively dilute solutions were used to follow its removal from solution using UV-vis spectroscopy. These studies from 10 mg of as-synthesized intact crystals of NDTB-1 show rapid uptake of TcO₄⁻ from solution with 72% being removed in 36 hours, as shown in FIG. 5, providing a K_{d} of 216 mL/g.

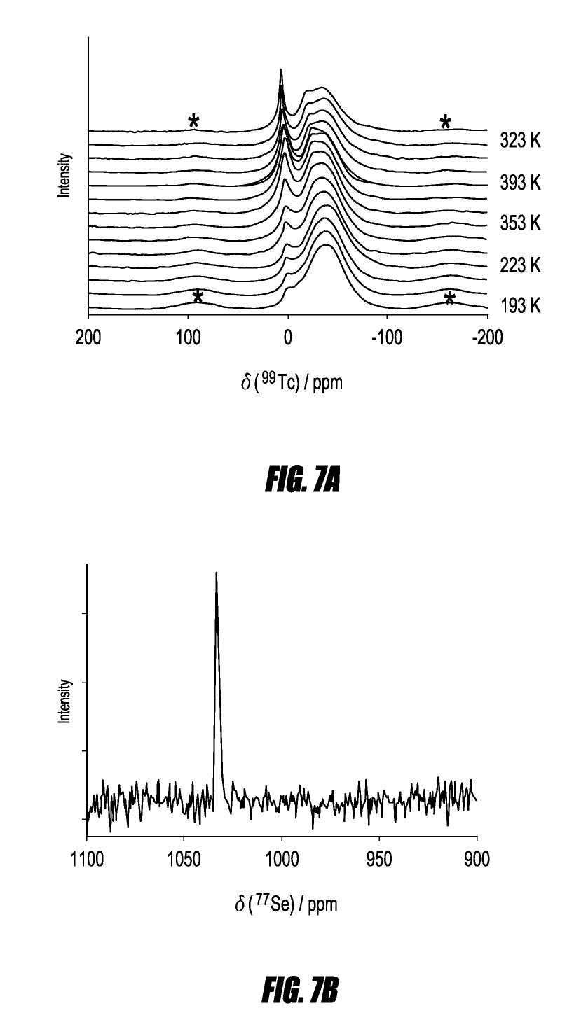

FIG. 7A illustrates an example of a ⁹⁹Tc MAS-NMR spectrum of NDTB-1. ⁹⁹Tc MAS-NMR spectroscopy was used to probe the behavior of TcO₄⁻ within the NDTB-1 structure. Although ⁹⁹Tc is quadrupolar (I=9/2), the symmetry of the TcO₄⁻ ion is sufficiently high that the quadrupolar broadening is limited and an aqueous TcO₄⁻ ion exhibits an inherent peak width of approximately 3 Hz in solution. The spectra in FIG. 7A show the presence of at least two sites where TcO₄⁻ ions reside in the material.

At 293 K, the two most conspicuous signals in the ⁹⁹Tc MAS NMR spectrum are a narrow peak near 0 ppm, with approximately 1.5 kHz full-width at half-maximum, and a broader peak centered near −40 ppm, with approximately 4.6 kHz full-width at half-maximum. The intensity of the sharp, narrow peak diminishes markedly with decreasing temperature. This is consistent with its assignment to TcO₄⁻ ions, which undergo rapid, near-isotropic tumbling near room temperature.

The NMR spectra in FIG. 7A are also consistent with the interpretation that the chemical environment around the ⁹⁹Tc nucleus is disturbed by the interaction with the cationic framework. As illustrated in FIG. 7A, the second conspicuous signal is a broader upfield signal centered near −40 ppm, accompanied by sets of spinning sidebands denoted by asterisks. The signal can be modeled with a broadened second-order central-transition quadrupolar lineshape, but is not well-constrained. Furthermore, the width and intensity of the spinning sidebands support an assignment to a dynamically rigid species, in contrast to a narrow downfield signal that suggests ion mobility. Here, the broad signal exhibits complex nutation with an apparent π/2 pulse width that is 2-3 times shorter than that for the narrow signal, suggesting that only the ⁹⁹Tc nuclei represented by the broad signal experience a significant quadrupolar interaction.

At 193 K, the smaller signal centered near 0 ppm contains about 6±1.5% of the total intensity. The reduction in intensity of this narrow signal with temperature indicates that all the ⁹⁹Tc transitions are dynamically averaged into a narrow signal at room temperature. When the sample cools, the dynamic averaging diminishes, thus causing the signals, which correspond to the satellite transitions, to be broadened into the baseline, therefore only leaving the central transition.

There is also evidence of a third signal on the broader peak at 293 K to 323 K near −20 ppm that appears to resemble fine structure from second-order quadrupolar broadening. However, the narrow features appear to broaden with reduced temperature and have nearly the same chemical shift as the signal centered near −40 ppm, thus suggesting instead the presence of a small amount of mobile TcO₄⁻ ions in chemical environments.

Thus, results from FIG. 7A of ⁹⁹Tc NMR experiments can show that both channels and the cages in NDTB-1 are occupied by TcO₄⁻ ions so that the net cationic charge of the framework is balanced. The narrow signal near 0 ppm can correspond to TcO₄⁻ ions in the channels, which is consistent with the greater space for movement available for the ions. The broader upfield signal centered near −40 ppm can be assigned to TcO₄⁻ ions in the cavities. Moreover, the ⁹⁹Tc NMR data show that the TcO₄⁻ ions in the cavities are significantly disordered.

FIG. 7B illustrates an example of a ⁷⁷Se MAS-NMR spectrum of NDTB-1. Here, NDTB-1 samples were exchanged with SeO₄²⁻ ions to examine the selectivity of the cationic framework. In contrast to the ⁹⁹Tc-MAS NMR signals, the ⁷⁷Se-MAS NMR signal of the NDTB-1 exchanged with SeO₄²⁻ ions produced only a single narrow signal, centered near 1045 ppm. The fact that the adsorption of SeO₄²⁻ ions gave only a single narrow signal suggests that the selectivity of NDTB-1 is based upon the size-to-charge ratios of the TcO₄⁻ and SeO₄²⁻ ions. The stronger coulombic interactions with the framework could lead to the exclusion of SeO₄²⁻ ions from the cages, though it is possible that the long T₁ values for ⁷⁷Se that the SeO₄²⁻ ions in the cavities relaxed too slowly for detection.

Therefore, NDTB-1 provides a cationic framework with the advantageous capacity to store the environmental contaminant TcO₄⁻ ion as well as other complex anionic contaminants. NDTB-1 was tested on nuclear waste solutions containing carbonate, sulfate, chloride, nitrate, and nitrite solutions in addition to TcO₄⁻ ion. Despite the presence of more than 300-fold excesses of chloride and nitrate ions, and a 15-fold excess of nitrite ions in a simulated low-activity melter recycle stream, NDTB-1 selectively removed TcO₄⁻ ions with a distribution coefficient K_{d} of 16.2-22.9 mL/g from the solution. Therefore, in accordance with preferred embodiments, NDTB-1 and/or one or more compounds according to Formula 1 (and hydrates thereof) may be blended, mixed, or otherwise combined or treated with target anions in solution, suspension or emulsion to result in the removal or sequestration of the anions. Such methods find use in removal of the anionic contaminants from the environment, industrial wastestreams, and other sources. Given the selectivity and degree of sequestration, such methods may find particularly beneficial use in the long-term storage of nuclear waste by providing for essentially non-leachable sequestration of pertechnetate and other harmful anions.

NDTB-1 and related compounds according to Formula 1 represent a supertetrahedral cationic framework with advantageous anion exchange capabilities. It is a purely inorganic 3D cationic framework. Also, the use of cerium, Ce (IV), in substitution with thorium, could demonstrate additional utility outside of the nuclear industry.

### Method of Manufacture

Th(NO₃)₄.4H₂O (0.2000 g), boric acid (0.6717 g), Millipore-water (90 μL) were loaded into a 23 mL autoclave. The autoclave was sealed and heated to 200° C. in a box furnace for 7 days. The autoclave was then cooled down to 160° C. at a rate of about 1° C./hour followed by cooling at a rate of 9° C./hour to room temperature. The product was washed with boiling water to remove excess boric acid, followed by rinsing with methanol. Crystals in the form of octahedra and their fragments were isolated. Crystals with improved morphology can be obtained by using Th(CO₃)₂ as the source of thorium. Single crystal X-ray diffraction and powder X-ray diffraction studies reveal that NDTB-1 can be made as a pure phase with a yield of 72.8% based on thorium.

The process described above can also be accomplished with a cerium containing starting material. For example, a starting material such as Ce₂O(NO₃)₆(H₂O)₆.2H₂O or (NH₄)₂Ce(NO₃)₆ can be used to manufacture a cerium analog.

X-ray structural analysis gathered the following data of [ThB₅O₆(OH)₆][BO(OH)₂].2.5H₂O (NDTB-1): colorless octahedron, crystal dimensions 0.131×0.132×0.134 mm, cubic, Fd³ (No. 203), Z=16, a=17.4036(16), V=5271.3(8) Å 3 (T=100 K), μ=114.15 cm⁻¹, R1=0.0194, wR2=0.0519. A Bruker APEXII Quazar diffractometer was configured with the following parameters: θₘₐₓ=57.78°, Mo Kα, λ=0.71073 Å, 0.5° ω scans, 15189 reflections measured, 579 independent reflections all of which were included in the refinement. The data was corrected for Lorentz-polarization effects and for absorption, structure was solved by direct methods, anisotropic refinement of F2 by full-matrix least-squares, 48 parameters. The program for crystal structure determination from single-crystal diffraction data can be described by G. M. Sheldrick, SHELXTL PC, Version 5.0, Siemens Analytical X-Ray Instruments, Inc.; Madison, Wis. 1994, the entirety of which is hereby incorporated by reference. Further details of the crystal structure investigation may be obtained from the Fachinformationzentrum Karlsruhe, D-76344 Eggenstein-Leopoldshafen, Germany (crysdata@fiz-karlsruhe.de) on quoting numbers CSD 421217.

While the components and techniques of the invention have been described with a certain degree of particularity, it is manifest that many changes may be made in the specific designs, constructions and methodology herein above described without departing from the spirit and scope of this disclosure. It should be understood that the invention is not limited to the embodiments set forth herein for purposes of exemplification, but is to be defined only by a fair reading of the appended claims, including the full range of equivalency to which each element thereof is entitled.

What is claimed is:

1. A composition comprising a compound having the formula:
[XB₅O₆(OH)₆][BO(OH)₂] or hydrates thereof,
wherein X is selected from the group consisting of Th or Ce.

2. The composition of claim 1, wherein [XB₅O₆(OH)₆][BO(OH)₂] or hydrates thereof comprise a porous supertetrahedral cationic framework.

3. The composition of claim 1, wherein the compound is [ThB₅O₆(OH)₆][BO(OH)₂].nH₂O, wherein 0≦n≦4.

4. A method of sequestering environmental contaminants, comprising:
treating a liquid with a compound represented by the formula, [XB₅O₆(OH)₆][BO(OH)₂].nH₂O, wherein X is selected from the group consisting of Th or Ce and 0≦n≦4.

5. The method of claim 4, wherein the environmental contaminant comprises chromate anions (CrO₄²⁻) or pertechnetate ions (TcO₄₋).

6. The method of claim 3, wherein the compound comprises [ThB₅O₆(OH)₆][BO(OH)₂].nH₂O, wherein 0≦n≦4.
